(19) United States
(12) Patent Application Publication
(10) Pub. No.: US 2025/0202682 A1
(43) Pub. Date: Jun. 19, 2025

(54) VEHICLE NETWORK SECURITY SYSTEM USING TIME SYNCHRONIZATION-BASED COUNTER MODE

(71) Applicant: HYUNDAI AUTOEVER CORP., Seoul (KR)

(72) Inventors: Sung Jin Choi, Seoul (KR); Dong Jae Won, Seoul (KR); Sang Won Kim, Seoul (KR)

(73) Assignee: HYUNDAI AUTOEVER CORP., Seoul (KR)

(21) Appl. No.: 18/948,140

(22) Filed: Nov. 14, 2024

(30) Foreign Application Priority Data
Dec. 13, 2023 (KR) 10-2023-0180264

(51) Int. Cl. H04L 9/06

(52) U.S. Cl. CPC H04L 9/065; H04L 9/0631; H04L 9/0637

(57) ABSTRACT

A vehicle network security system using a time synchronization-based counter mode includes an encryption unit that obtains a key stream through a first counter (CTR) and obtains cipher text by performing an operation on plain text to be encrypted and the key stream. The vehicle network security system also includes a decryption unit that obtains the key stream through a second counter and obtains the plain text by performing the operation on the cipher text and the key stream. The first counter and the second counter use a factor synchronized with time data transferred from hardware clocks (HCs) included in electronic control units (ECUs) in a vehicle network.

### CROSS REFERENCE TO RELATED APPLICATION

This application claims the benefit of and priority to Korea Patent Application No. 10-2023-0180264, filed on Dec. 13, 2023, the entire contents of which are hereby incorporated herein by reference.

### FIELD OF TECHNOLOGY

The present disclosure relates to a vehicle network security system.

### BACKGROUND

A counter mode is one of the encryption modes that are used in block encryption, and is a type of stream cipher that uses a counter to encrypt a block. An encryption and decryption algorithm technology using this counter mode guarantees uniqueness for a series of values that increase for each block. Time synchronization is important to enhance security.

An encryption and decryption algorithm technology using a counter mode of the related art has problems in the field of vehicle network security due to difficulties in precise time synchronization and data security. Safe data transmission and rapid response are important for a stable vehicle network. An algorithm of the related art has taken an approach such as introducing a separate hardware counter for precise synchronization between network devices.

However, this approach was only used as a means for compensating for the irregularity of packet transmission and maintaining synchronization between algorithms, and has difficulty in guaranteeing practical safety and rapid response in vehicle network security.

Generally, in an encryption and decryption algorithm, counters of respective nodes must be perfectly synchronized, but it was technically difficult to implement time synchronization between devices in a special environment of a vehicle network. This is because guaranteeing the time synchronization between network devices while vehicles are operating in various environments has a practical difficulty in providing reliable communication and security functions.

### SUMMARY

An object of the present embodiment is to provide a counter mode encryption and decryption algorithm based on precise time synchronization by using hardware clock configurations included in electronic control units (ECUs) of a vehicle network.

Further, another object of the present embodiment is to provide a vehicle network security system using a counter mode encryption and decryption algorithm based on time synchronization.

Further, yet another object of the present embodiment is to provide a vehicle network security apparatus and method using a vehicle network security system to which a time synchronization-based counter mode is applied.

At least some embodiments of the present disclosure may improve the safety and efficiency of a vehicle network by implementing precise synchronization without excessive cost investment in vehicle network security, reducing complexity, and making maintenance easy.

According an embodiment, a vehicle network security system using a time synchronization-based counter mode is provided. The vehicle network security system includes an encryption unit configured to obtain a key stream through a first counter (CTR) and obtain cipher text by performing an operation on plain text to be encrypted and the key stream. The vehicle network security system also includes a decryption unit configured to obtain the key stream through a second counter and obtain the plain text by performing the operation on the cipher text and the key stream. The first counter and the second counter use a factor synchronized with time data transferred from hardware clocks (HCs) included in electronic control units (ECUs) in a vehicle network.

The key stream may be obtained through an advanced encryption standard (AES) encryption algorithm.

The operation performed with the key stream in the encryption unit or the decryption unit may include an exclusive OR (XOR) operation.

The encryption unit and the decryption unit may perform encryption and decryption using the same key stream.

The ECU may include an application layer including an application software program, a hardware layer including a hardware configuration, and an adaptive platform layer for an interaction between the application layer and the hardware layer.

The hardware clock may be included in the hardware layer, and the hardware clock may include a hardware clock for an Ethernet-based precision time protocol (PTP).

The factor synchronized with the time data may be acquired using a pulse per second (PPS) signal.

The PPS signal may be acquired by connecting a software defined pin (SDP) output of an Ethernet controller included in the hardware layer to an SDP Input and then performing a setting so that a pulse is periodically emitted from the SDP output.

A signal handler used to process a rising edge of the pulse may be registered in the application software program, and the time data may be acquired within the registered signal handler.

The first counter and the second counter may have a time error value of 100 nanosecond (ns) or less by using the factor synchronized with the time data.

The first counter and the second counter may use time data in a microsecond (μs) or more.

According to an embodiment, a vehicle network security communication method using a time synchronization-based counter mode is provided. The vehicle network security communication method includes an encryption step of obtaining a key stream through a first counter and obtaining cipher text by performing an operation on plain text to be encrypted and the key stream. The vehicle network security communication method also includes a decryption step of obtaining the key stream through a second counter and performing the operation on the cipher text and the key stream to obtain the plain text. The first counter and the second counter use a factor synchronized with time data transferred from hardware clocks (HCs) included in hardware layers of electronic control units (ECU) in a vehicle network.

The encryption step may include: a first counter generation step of acquiring a factor synchronized with the time data through a PPS signal received by an application software program included in an application layer of the ECU and generating the first counter using the factor; a key stream generation step of obtaining the key stream through the first counter; a first calculation step of performing the operation on the plain text to be encrypted and the key stream to obtain the cipher text; and a cipher text transmission step of transmitting the cipher text through the vehicle network.

The decryption step may include a second counter generation step of acquiring a factor synchronized with the time data through a PPS signal received by an application software program included in an application layer of the ECU and generating the second counter using the factor; a key stream generation step of obtaining the key stream through the second counter; and a second operation step of performing the operation on the cipher text and the key stream to obtain the plain text.

The first counter generation step performed in the encryption step and the second counter generation step performed in the decryption step may be performed at the same point in time.

The key stream generation step performed in the encryption step and the key stream generation step performed in the decryption step may be performed at the same point in time.

A time required for the first calculation step and the cipher text transmission step performed in the encryption step is longer than a time required for the second counter generation step and the key stream generation step performed in the decryption step.

The PPS signal used in the first counter generation step performed in the encryption step and the second counter generation step performed in the decryption step may be acquired by connecting a software defined pin (SDP) output of an Ethernet controller included in the hardware layer to an SDP Input and then performing a setting so that a pulse is periodically emitted from the SDP output.

A period of the pulse may be longer than a time required for the first counter generation step, the key stream generation step, the first calculation step, and the cipher text transmission step included in the encryption step.

According to yet an embodiment, a vehicle network security apparatus using a time synchronization-based counter mode is provided. The vehicle network security apparatus includes an encryption unit configured to obtain a key stream through a first counter (CTR) and obtain cipher text by performing an operation on plain text to be encrypted and the key stream. The vehicle network security apparatus also includes a decryption unit configured to obtain the key stream through a second counter and obtain the plain text by performing the operation on the cipher text and the key stream. The first counter and the second counter use a factor synchronized with time data transferred from hardware clocks (HCs) included in hardware layers of electronic control units (ECUs) in a vehicle network, and the first counter and the second counter have a time error value of 100 ns or less by using the factor synchronized with the time data.

The first counter and the second counter may use time data in a us or more.

As described above, according to embodiments of the present embodiment, it is possible to provide a vehicle network security system that secures uniqueness and security through a counter mode encryption and decryption algorithm based on precise time synchronization by using hardware clock configurations included in the electronic control units (ECUs) of the vehicle network.

According to embodiments of the present embodiment, it is also possible to provide a vehicle network security system capable of guaranteeing safety and speed economically and simply without introducing a separate hardware counter since the ECU included in the vehicle network itself is used.

According to embodiments of the present embodiment, it is also possible to provide a vehicle network security system capable of guaranteeing time synchronization between network devices of vehicles operating in various environments.

The technical problems to be achieved by the present disclosure are not limited to the technical problems mentioned above. Other technical problems that are not mentioned herein should be more clearly understood by those having ordinary skill in the art to which the present disclosure pertains from the following description.

### BRIEF DESCRIPTION OF THE DRAWINGS

FIG. 1 is a block diagram illustrating a vehicle network security system, according to an embodiment.

FIG. 2 is a diagram illustrating operations that are performed with a key stream in an encryption unit or a decryption unit, according to an embodiment.

FIG. 3 is a schematic diagram illustrating an ECU, according to an embodiment.

FIG. 4 is a diagram illustrating an example in which a plurality of ECUs in a vehicle network use the same time band through time synchronization, according to an embodiment.

FIG. 5 is a diagram illustrating an example in which a PPS signal is acquired, according to an embodiment.

FIG. 6 is a flowchart showing a vehicle network security communication method, according to an embodiment.

FIG. 7 is a flowchart showing an encryption step, according to an embodiment.

FIG. 8 is a flowchart showing a decryption step, according to an embodiment.

### DETAILED DESCRIPTION

Hereinafter, embodiments of the present disclosure are described in detail with reference to the accompanying drawings. When components in respective drawings are denoted by reference signs, it should be noted that the same components are denoted by the same signs as much as possible even when the components are shown on different drawings. Further, when the present disclosure is described, where it was judged that specific description of related known configurations or functions may obscure the gist of the present disclosure, detailed description thereof has been omitted.

Further, when components of the present disclosure are described, terms such as first, second, A, B, (a), and (b) may be used. These terms are only intended to distinguish the components from other components. The nature, order, or sequence of the components is not limited by the terms. When a component is described as being “connected” or “coupled” to another component, it should be understood that the component may be directly connected or coupled to the other component, but another component may also be “connected” or “coupled” between respective components.

The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

When a component, device, unit, module, element, or the like of the present disclosure is described as having a purpose or performing an operation, function, or the like, the component, device, or element should be considered herein as being “configured to” meet that purpose or perform that operation or function.

An embodiment of the present disclosure provides a vehicle network security system using a time synchronization-based counter mode. The vehicle network security system may include an encryption unit configured to obtain a key stream through a first counter (CTR) and obtain cipher text by performing an operation on plain text to be encrypted and the key stream. The vehicle network security system may also include a decryption unit configured to obtain the key stream through a second counter and obtain the plain text by performing the operation on the cipher text and the key stream. The first counter and the second counter may use a factor synchronized with time data transferred from hardware clocks (HCs) included in electronic control units (ECUs) in a vehicle network.

The vehicle network security system according to an embodiment of the present disclosure may use a counter mode encryption/decryption algorithm.

The counter mode encryption/decryption algorithm is one of the block cipher operation modes and is one of the effective methods capable of providing confidential data. The counter mode encryption/decryption algorithm is used for block encryption, and is characterized by generating a key stream through a counter that increases constantly each time each block is encrypted. This counter mode encryption/decryption algorithm may provide both high-performance encryption capability and advantages of parallelization while minimizing dependency between blocks.

It is necessary to generate a counter in order to start the counter mode encryption/decryption algorithm. The generated counter is characterized by increasing constantly when a block is encrypted, and may act as an important component in generating a key stream for each block.

Further, a specific operation may be performed to encrypt a plain text block. Through this, a cipher text block may be created, and data may be encrypted while minimizing dependency with existing blocks.

The counter mode encryption/decryption algorithm may be considered as a type of stream cipher similar to an output feedback (OFB) mode encryption/decryption algorithm. However, the counter mode encryption/decryption algorithm is characterized by directly generating a key stream using a counter value, unlike the OFB mode.

Further, the counter mode encryption/decryption algorithm may use a similar structure for encryption and decryption. Therefore, since implementing encryption/decryption is simple and consistency may be maintained, stability may be provided between an encryption process and a decryption process.

The counter mode encryption/decryption algorithm has the advantage of being able to arbitrarily change the order of processing blocks. This is because the order of blocks may be predicted through a counter value. Therefore, the characteristics of the counter mode encryption/decryption algorithm may be advantageous in parallel processing.

The counter mode encryption/decryption algorithm may maintain security by using a unique counter value for each block while using the same counter value.

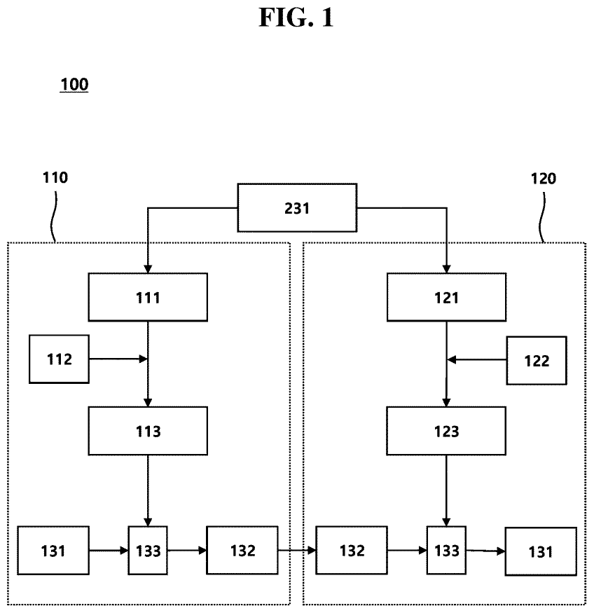

FIG. 1 is a block diagram illustrating a vehicle network security system, according to an embodiment.

Referring to FIG. 1, the vehicle network security system 100 may include an encryption unit 110 and a decryption unit 120.

In the encryption unit 110, a first counter 111 may first be generated, and then a key stream 113 may be obtained through an encryption algorithm (e.g., advanced encryption standard (AES)) 112 using the first counter 111. The key stream 113 may be used to convert plain text to cipher text, and cipher text 132 may be obtained by performing an operation 133 on plain text 131 to be encrypted and the key stream 113.

In the decryption unit 120, a second counter 121 may first be generated, and then a key stream 123 may be obtained through an encryption algorithm (e.g., AES) 122 using the second counter 121. The key stream 123 may be used to convert the cipher text into plain text, and the cipher text 132 to be decrypted and the key stream 123 may be subjected to the operation 133 to obtain the plain text 131.

The first counter 111 and the second counter 121 may receive and use factors transferred from hardware clocks (HCs) 231 included in the electronic control units (ECUs) in the vehicle network. Here, the factor transferred to the first counter 111 and the second counter 121 may be a factor synchronized with the time data. Therefore, the first counter 111 and the second counter 121 may be generated in synchronization with time data information in the vehicle network, thereby guaranteeing the uniqueness and security of the counter mode encryption/decryption algorithm.

Further, after the cipher text 132 is generated in the encryption unit 110, the cipher text 132 may be transmitted to a reception unit of another ECU through a transmission unit, and the cipher text 132 may be converted back into the plain text 131 in the decryption unit 120 of the other ECU. Here, when the cipher text 132 is converted into the plain text 131 in the other EUC after the plain text 131 is converted into the cipher text 132, the key streams 113 and 123 to be used may be the same.

The key stream 113 obtained through the first counter 111 and the key stream 123 obtained through the second counter 121 may be generated through the encryption algorithms 112 and 122.

The encryption algorithms 112 and 122 may include the advanced encryption standard (AES).

AES is a symmetric key encryption standard and has been developed to replace existing data encryption standard (DES) and 3DES. Since the advanced encryption standard may provide relatively secure block encryption, the advanced encryption standard may be used for IT security and network communication.

The advanced encryption standard may provide high-level security. In the advanced encryption standard, a fixed-size block may be processed using a block encryption scheme, and the block may be converted from plain text to cipher text. Here, since a key length may be selected as 128 bits, 192 bits, or 256 bits, various security levels may be supported.

A process of increasing nonlinearity and performing data mixing and substitution by using sub-byte conversion and a shuffling operation may be performed in the advanced encryption standard. Here, the data is processed in several stages using a round structure, and in each round, a key may be expanded and a subkey may be generated. The subkey generated in this way may be used for encryption in each round so that overall security may be improved.

Further, the advanced encryption standard may provide stability and efficiency at the same time based on a core principle and a mathematical scheme of block encryption.

Therefore, according to an embodiment of the present disclosure, a key stream may be generated by using an advanced encryption standard with high security in the counter mode encryption/decryption algorithm, and cipher text may be generated through the generated key stream.

The key stream 113 of the encryption unit 110 may be generated through the encryption algorithm 112 using the first counter 111 and a separate key. Further, the key stream 123 of the decryption unit 120 may also be generated through an encryption algorithm 122 using the second counter 121 and a separate key. The operation 133 performed on the plain text 131 or the cipher text 132 and the key streams 113 and 123 in the encryption unit 110 or the decryption unit 120 may include an exclusive OR (XOR) operation.

In general, operations that may be used in the field of encryption/decryption may include XOR (Exclusive OR), AND (logical AND), OR (logical OR), NOT (logical NOT), shift (left shift and right shift), rotate (rotate left and rotate right), addition (modular addition), and/or bitwise multiplication.

The XOR (exclusive OR) operation is a bit operation in which 1 is output when two bits are different from each other, and 0 is output when two bits are the same as each other. In encryption/decryption, the XOR operation may be used for bit-by-bit manipulation between a key and plain text or cipher text. The XOR operation can be calculated quickly to guarantee speed, and has a characteristic of returning to an original value when the XOR operation is applied to the same bit twice.

The AND (logical AND) operation is a bit operation in which 1 is output when two bits are 1 and 0 is output otherwise. In the encryption/decryption, this AND operation may be used to mask a specific bit pattern or extract a bit.

The OR (logical OR) operation is a bit operation in which 1 is output when at least one of the two bits is 1, and 0 is output only when the two bits are 0. This OR operation may be used to set bits.

The NOT (logical NOT) operation is a bit operation in which a value opposite to a value of an input bit is output. The NOT operation may be used to flip a value of a specific bit.

The shift operation (left shift and right shift) is an operation that may be used to move a bit to the left or right. In the shift operation, a space that becomes empty due to the movement is filled with 0. This shift operation may be used to rotate or move data.

The rotate operation (rotate left and rotate right) is an operation that may be used to rotate a bit to the left or right. In the rotate operation, a space that becomes empty due to the rotation is filled in an opposite direction to a rotation direction.

The addition (modular addition) operation is an addition operation between bits or bytes. Generally, a modular operation that takes a remainder of an addition result being divided by a specific value may be used to prevent overflow.

The bitwise multiplication is a bit-based multiplication operation and may be used for matrix transformation or the like in an encryption algorithm.

An encryption/decryption operation according to an embodiment of the present disclosure tries to use the property of the exclusive OR (XOR) operation in which an original value is returned when the same bit is subjected to an operation twice. Therefore, the exclusive OR (XOR) operation may be used for the operation 133 that is used when plain text is encrypted into cipher text and the operation 133 that is used when cipher text is decrypted into plain text.

Further, the encryption unit 110 and the decryption unit 120 may perform encryption and decryption by using the same key streams 113 and 123. Therefore, it is possible to perform the encryption and the decryption simply and quickly by using the same key streams 113 and 123 according to the property of the exclusive OR (XOR) operation.

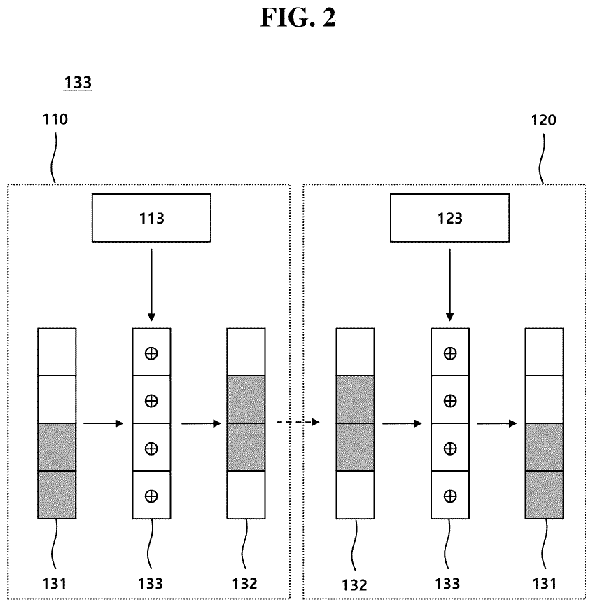

FIG. 2 is a diagram illustrating an operation that is performed with the key stream in the encryption unit or the decryption unit, according to an embodiment.

Referring to FIG. 2, the encryption unit 110 may perform an operation 133 on the plain text 131 and the key stream 113 to generate the cipher text 132 and may transmit the generated cipher text 132 to the decryption unit 120. The decryption unit 120 may then perform the operation 133 on the cipher text 132 with the key stream 123 to decrypt the cipher text 132 back into the plain text 131.

For example, the operation 133 used for encryption and decryption may be an XOR operation, and the key streams 113 and 123 used for the operation 133 may be the same. Therefore, the cipher text 132 obtained by performing the operation 133 on the plain text 131 with the key stream 113 is subjected to the operation 133 with the same key stream 123 according to characteristics of the XOR operation so that the cipher text 132 may be decrypted into the original plain text 131.

The plain text 131 and the cipher text 132 illustrated in FIG. 2 are only examples, and a relevant block may be transformed into another form and used.

The first counter 111 and the second counter 121 may use the factor synchronized with the time data transferred from the hardware clocks (HCs) included in the electronic control units (ECUs) in the vehicle network.

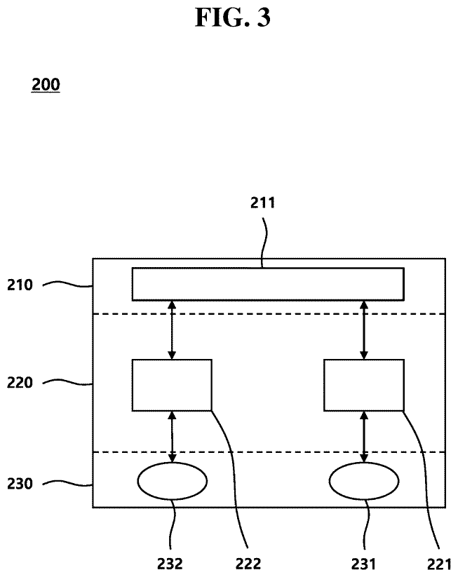

FIG. 3 is a schematic diagram illustrating an ECU, according to an embodiment.

Referring to FIG. 3, an ECU 200 according to an embodiment may include an application layer 210, an adaptive platform layer 220, and a hardware layer 230.

The application layer 210 may include an application software program 211. The hardware layer 230 may include major hardware configurations required for an operation of the ECU 200. The adaptive platform layer 220 may include a platform required for an interaction between the application layer 210 and the hardware layer 230.

An ECU that is used in a vehicle network system is a major configuration that comprehensively controls and manages various functions of a vehicle.

The various functions of the vehicle may be implemented through the application software program 211 that is executed in the application layer 210. For example, functions of a driving safety system, vehicle information and related entertainment, a communication system, and the like may be included. The application software program 211 included in the application layer 210 may determine related tasks for performing various functions of the vehicle and communicate with the hardware layer 230 to adjust an operation of the vehicle according to the determination.

The hardware layer 230 may be responsible for physical components of the ECU 200. For example, the hardware layer 230 may include sensors, actuators, processors, memories, communication ports, and/or the like. The hardware layer 230 may perform the tasks determined by the application layer 210, and may collect data from sensors or have an influence on the outside through actuators. The hardware layer 230 may provide a standardized interface and hardware abstraction to secure flexibility and interoperability.

The adaptive platform layer 220 is a configuration for supporting advanced functions for the interaction between the application layer 210 and the hardware layer 230. The adaptive platform layer 220 may provide a dynamic software architecture and may support functions that may be updated at runtime. Further, the adaptive platform layer 220 may perform a function for integrating new technologies that are applied to vehicles, such as automated driving, and may provide flexibility for upgrading and changing a system even when a vehicle is traveling.

For the adaptive platform layer 220 according to an embodiment of the present disclosure, an automotive open system architecture (AUTOSAR) standard may be applied.

The AUTOSAR standard is one of the international standards for standardizing automotive software and electronic systems. The AUTOSAR may be used to support efficient development, integration, and maintenance of software throughout an entire life cycle of a vehicle. In particular, the AUTOSAR may provide interoperability with a standard interface between software components that are executed on various ECUs of the vehicle.

The AUTOSAR may define and abstract the standard interface. Communication between the software components may be facilitated by defining the standard interface. Through this, interoperability between various ECUs may be secured. Further, the AUTOSAR may provide a flexible and reusable software architecture by separating software from hardware while hiding hardware dependency through abstraction.

Further, the AUTOSAR may provide platform independence to provide software reuse on various hardware platforms. This improves software portability and facilitates system upgrades. Additionally, the AUTOSAR supports dynamic software updates and extensions so that requirements changing during the life cycle of the vehicle may be supported.

Further, the AUTOSAR may provide a framework that defines a standardized software architecture. Based on this, a template that defines structures and interactions of software components may be provided. The framework and the template may support efficient development by maintaining consistency in software development and providing a standardized structure.

The AUTOSAR has a configurable structure, allowing vehicle manufacturers and system suppliers to adjust software to their needs. This may enable solutions that support various vehicle types and models.

Further, the AUTOSAR may provide a standardized communication stack for in-vehicle communication. This facilitates communication between various ECUs, and improves an interaction in a distributed system.

According to an embodiment of the present disclosure, the AUTOSAR standard is applied in the adaptive platform layer 220 so that the dynamic software architecture for various functions of the vehicle may be provided. This may contribute to standardizing and optimizing the software architecture in the ECU 200 of the vehicle network, and there is an advantage of providing flexibility and efficiency to a vehicle manufacturer and s system developer.

The hardware layer 230 may include the hardware clock (HC) 231. The hardware clock 231 may include a hardware clock for Ethernet-based precision time protocol (PTP).

The PTP is a protocol that is used to accurately synchronize time in a network system. Since the PTP synchronizes the time with the accuracy of several hundred nanoseconds (ns) per second, the PTP is an important configuration for precise time synchronization.

The PTP is a protocol for providing consistent time among a large number of devices in a network. The PTP enables synchronization between devices using an accurate time stamp in a communication network, and may contribute to satisfy precise timing requirements.

The PTP may use a master-slave architecture. One device may be designated as a master to provide accurate time, and other devices may be synchronized to this master device. In the PTP, network delay is measured, synchronization between devices is adjusted, and an accurate timing is maintained.

The PTP may follow the IEEE 1588 standard. The IEEE 1588-2008 standard is generally used, and may also be called PTPv2. In the PTP, communication may be performed based on user datagram protocol (UDP) and timing information may be exchanged between devices on a network.

The PTP operates in a way in which each device periodically exchanges a timestamp and measures network delay based on the timestamp to perform synchronization. In this case, in the PTP, a network latency is measured and compensated so that the devices may actually use the same time.

The PTP may play an important role of enabling improvement of system performance, data accuracy, and cooperation between distributed systems, by being applied for the time synchronization of the network system.

The hardware clock for Ethernet-based precision time protocol (PTP) may be called a PTP hardware clock (PHC).

The PHC is a configuration for precise time synchronization between network devices, and may play a key role in a situation in which precise timing and synchronization are essential in a high-performance network or communication system. The PHC is used while implementing the PTP protocol in the network devices, thereby providing high accuracy and stability.

The PTP is a protocol for accurately synchronizing times between network devices, and may be used especially in an environment in which precise time synchronization in second or less is required. The PHC may overcome software-level constraints and may enable stable synchronization in a high-performance network, by providing such precise synchronization at a hardware level.

The PHC is a clock that operates at an actual hardware level, not a software clock. Accordingly, the PHC may provide high accuracy and stability by using physical signals and hardware resources. Therefore, time synchronization through the PTP may be used in an environment in which high precision is required.

The PTP exchanges time signals at fixed time intervals for precise synchronization between network devices. The PHC enables network devices to refer to the same time while supporting an operation of the PTP in hardware, and helps maintain consistency and accuracy of communication.

In relation to an automotive network, precise time synchronization is essential in advanced driver assistance systems (ADAS) and automated driving technology, and therefore, the PHC may use as a main configuration. Since a precise timing is required between various sensors, actuators, and communication systems in a vehicle, the PHC may satisfy such a requirement in the automotive network and enable smooth and accurate communication between vehicle systems.

Further, the PHC may generate and manage a PTP hardware time stamp. The network device attaches time stamps to data packets to guarantee correct order of communication, which may be especially critical in real-time communication. The PHC may generate and manage these time stamps to guarantee correct order of arrival of the data packets in the network.

Further, the PHC may provide a consistent time reference between several devices within the same network. This is important in an environment where cooperation or linkage between various devices is required, and an accurate timing greatly contributes to the efficiency and stability of communication.

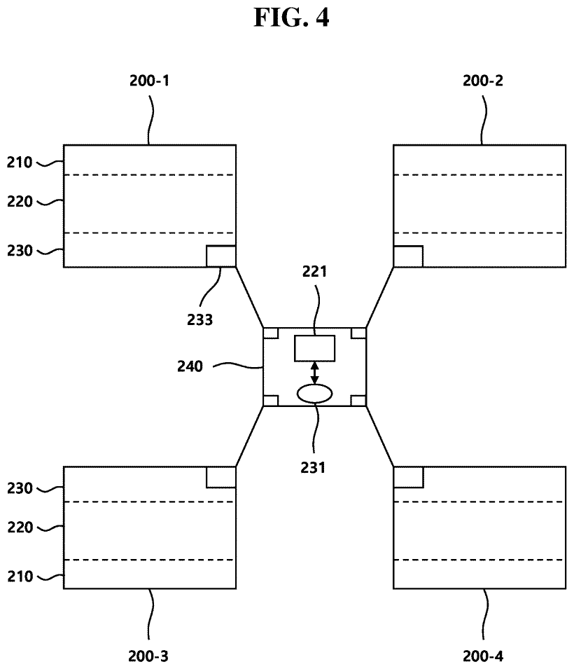

FIG. 4 is a diagram illustrating an example in which a plurality of ECUs in the vehicle network use the same time band through time synchronization, according to an embodiment.

Referring to FIG. 4, a plurality of ECUs 200-1, 200-2, 200-3, and 200-4 may be connected to a switch unit 240 through Ethernet ports 233 included in the hardware layer 230. This makes it possible for the plurality of ECUs 200-1, 200-2, 200-3, and 200-4 to synchronize the same time data, and all the ECUs in the vehicle network to use the same time band.

The factor synchronized with the time data may be acquired using a pulse per second (PPS) signal.

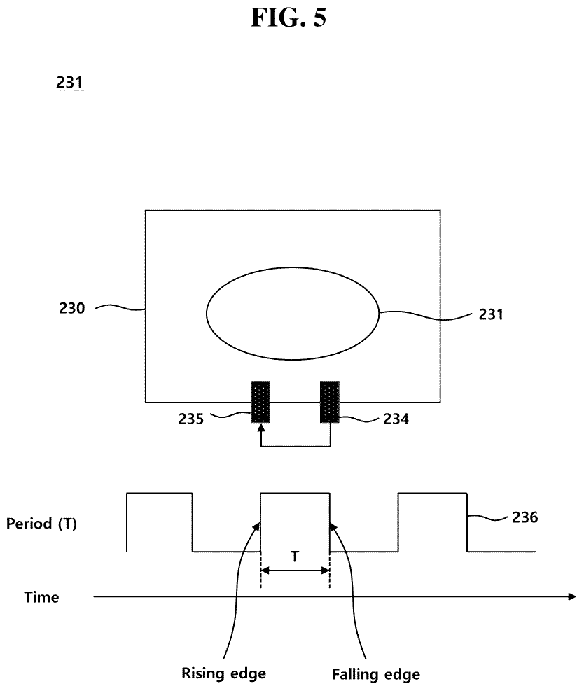

FIG. 5 is a diagram illustrating an example in which the PPS signal is acquired, according to an embodiment.

Referring to FIG. 5, a software defined pin (SDP) output 234 and an SDP input 235 of an Ethernet controller included in the hardware layer 230 are connected, and then a setting is performed so that a pulse 236 is periodically emitted from the SDP output 234, thereby acquiring the PPS signal.

A signal handler to be used to process a rising edge of the pulse 236 may be registered in the application software program 211, and the time data may be acquired within the registered signal handler.

For example, the acquisition of the time data through the PPS signal may be a process in which a start time t at the SDP output 234 and a period T of the pulse 236 are designated so that the pulse 236 is periodically emitted, and the application software program 211 may register a signal handler that processes a rising edge event of the pulse 236 and then call GetTime within the registered signal handler to acquire the time data.

Accordingly, when the application software program 211 receives the PPS signal in each period T of the pulse 236, GetTime is called through a time synchronization platform 221 to acquire the time data.

The first counter 111 and the second counter 121 are generated by using the factor synchronized with the time data acquired in this way.

The key stream 113 may be obtained through the generated first counter 111 and then the plain text 131 and the key stream 113 may be subjected to the operation 133 to obtain the cipher text 132. Further, the key stream 123 may be obtained through the generated second counter 121 and then the cipher text 132 and the key stream 123 may be subjected to the operation 133 to obtain the plain text 131.

Therefore, the first counter 111 and the second counter 121 may have a time error value of 100 nanoseconds (ns) or less by using the factor synchronized with the time data transferred from the hardware clock 231.

Since the time data transferred from the hardware clock 231 may have a time error value of 100 ns or less, the time data in a microsecond (μs) or more may always have the same value from the time stamp confirmed at each rising edge of the PPS signal. Accordingly, the first counter 111 and the second counter 121 may always have the same value of time data in a us or more.

Therefore, the first counter 111 and the second counter 121 may use time data in us or more.

Further, since the vehicle network security system 100 according to the embodiment of the present disclosure uses the counter mode encryption/decryption algorithm, an error may not be transferred to a subsequent block even when an error occurs once in a feedback algorithm in the block encryption algorithm.

Next, a vehicle network security communication method using a time synchronization-based counter mode according to an embodiment of the present disclosure is described in detail.

The vehicle network security communication method using a time synchronization-based counter mode according to an embodiment of the present disclosure may include an encryption step or operation of obtaining the key stream 113 through the first counter 111 and obtaining the cipher text 132 by performing the operation 133 on the plain text 131 to be encrypted and the key stream 113. The vehicle network security communication method may also include a decryption step or operation of obtaining the key stream 123 through the second counter 121 and obtaining the plain text 131 by performing the operation 133 on the cipher text 132 and the key stream 123. The first counter 111 and the second counter 121 may use the factor synchronized with the time data transferred from the hardware clock (HC) 231 included in the hardware layer 230 of the electronic control unit (ECU) 200 in the vehicle network.

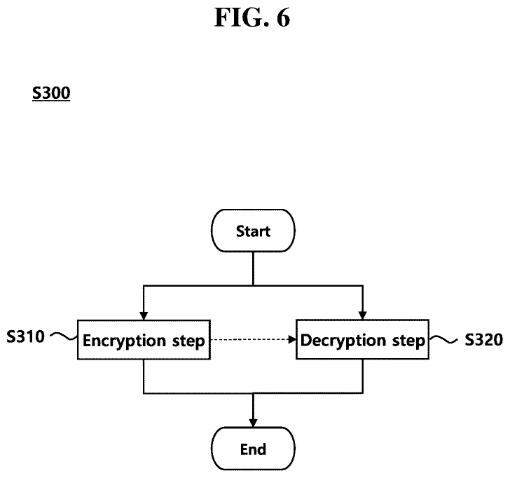

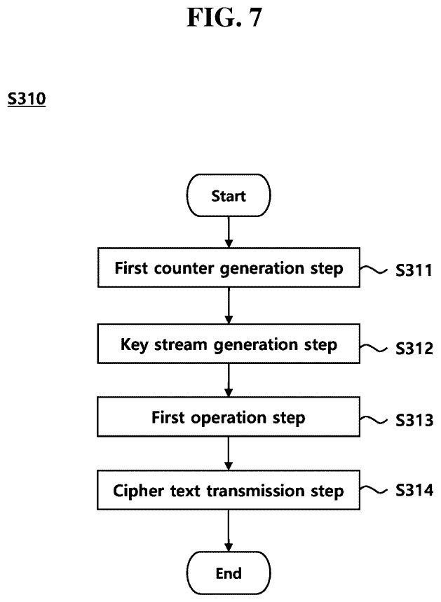

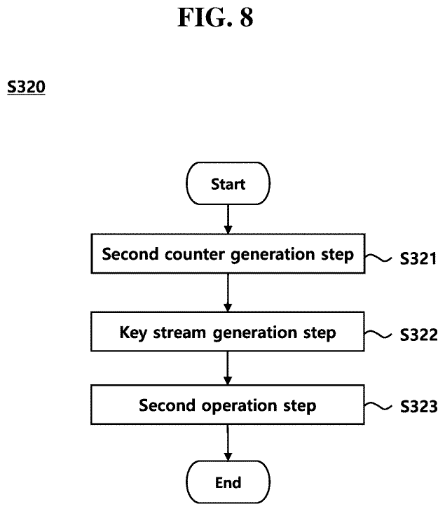

FIG. 6 is a flowchart showing a vehicle network security communication method according to an embodiment. FIG. 7 is a flowchart showing an encryption step or operation according to an embodiment. FIG. 8 is a flowchart showing a decryption step or operation according to an embodiment.

Referring to FIGS. 6-8, a vehicle network security communication method S300 using a time synchronization-based counter mode according to an embodiment may include an encryption step or operation S310 of obtaining the key stream 113 through the first counter 111 and obtaining cipher text 132 by performing the operation 133 on plain text 131 to be encrypted and the key stream 113. The vehicle network security communication method S300 may also include a decryption step or operation S320 of obtaining the key stream 123 through the second counter 121 and obtaining the plain text 131 by performing the operation 133 on the cipher text 132 and the key stream 123.

The encryption step or operation S310 may include a first counter generation step or operation S311 of acquiring the factor synchronized with the time data through the PPS signal received by the application software program 211 included in the application layer 210 of the ECU 200 and generating the first counter 111 using the acquired factor. The encryption step or operation S310 may also include a key stream generation step or operation S312 of obtaining the key stream 113 through the generated first counter 111. The encryption step or operation S310 may additionally include a first calculation step or operation S313 of performing the operation 133 on the plain text 131 to be encrypted and the key stream 113 to obtain the cipher text 132. The encryption step or operation S310 may further include a cipher text transmission step or operation S314 of transmitting the cipher text 132 through the vehicle network.

In an embodiment, in the first counter generation step or operation S311, when the application software program 211 receives the PPS signal in each period T of the pulse 236, GetTime is called through the time synchronization platform 221 to acquire the time data and the first counter 111 may be generated by using the factor synchronized with the acquired time data.

In the key stream generation step or operation S312, the generated first counter 111 may be used to generate the key stream 113 through an encryption algorithm. Here, the key stream 113 may be acquired through an advanced encryption standard (AES) encryption algorithm.

In the first operation or calculation step or operation S313, the plain text 131 to be encrypted and the key stream 113 are subjected to the operation 133 to obtain the cipher text 132. Here, the operation 133 performed with the key stream 113 may include an exclusive OR (XOR) operation.

In the cipher text transmission step or operation S314, the obtained cipher text 132 may be transmitted to a system requiring the cipher text 132 through the transmission unit in the vehicle network.

In an embodiment, before the first counter generation step or operation S311, the transmission unit may transmit information on the time t and the period T of the pulse 236 to the reception unit in advance.

The decryption step or operation S320 may include a second counter generation step or operation S321 of acquiring the factor synchronized with the time data through the PPS signal received by the application software program 211 included in the application layer 210 of the ECU 200 and generating the second counter 121 using the acquired factor. The decryption step or operation S320 may also include a key stream generation step or operation S322 of obtaining the key stream 123 through the generated second counter 121. The decryption step or operation S320 may additionally include a second operation step or operation S323 of obtaining the plain text 131 by performing the operation 133 on the cipher text 132 and the key stream 123.

In an embodiment, in the second counter generation step or operation S321, when the application software program 211 receives the PPS signal in each period T of the pulse 236, GetTime is called through the time synchronization platform 221 to acquire the time data, and the second counter 121 may be generated by using the factor synchronized with the acquired time data.

In the key stream generation step or operation S322, the key stream 123 may be generated through an encryption algorithm by using the generated second counter 121. Here, the key stream 123 may be obtained through the advanced encryption standard (AES) encryption algorithm.

After the key stream generation step or operation S322, the method may include waiting until the cipher text 132 transmitted from the transmission unit is received.

In the second operation step or operation S323, the cipher text 132 transmitted from the transmission unit and the key stream 123 are subjected to the operation 133 to obtain the plain text 131. Here, the operation 133 performed with the key stream 123 may include an exclusive OR (XOR) operation.

In an embodiment, the first counter generation step (S311) to be performed in the encryption step or operation S310 and the second counter generation step or operation S321 to be performed in the decryption step or operation S320 may be performed at the same point in time. In other words, in a vehicle network security communication method according to an embodiment of the present disclosure, parallel data processing may be possible since the time synchronization-based counter mode is used.

Further, a time required for the first operation or calculation step or operation S313 and the cipher text transmission step or operation S314 performed in the encryption step or operation S310 may be longer than a time required for the second counter generation step or operation S321 and the key stream generation step or operation S322 performed in the decryption step or operation S320. Through this, the first counter 111 and the second counter 121 may be generated through the PPS signal using the pulse 236 having a constant period T, and the encryption/decryption algorithm to which the first counter 111 and the second counter 121 are applied may be stably operated.

In an embodiment, the PPS signal used in the first counter generation step or operation S311 to be performed in the encryption step or operation S310 and the second counter generation step or operation S321 to be performed in the decryption step or operation S320 may be acquired by connecting the software defined pin (SDP) output 234 and the SDP input 235 of the Ethernet controller included in the hardware layer 230 and then performing a setting so that a pulse is periodically emitted from the SDP output 234.

Here, the signal handler to be used to process the rising edge of the pulse 236 may be registered in the application software program 211, and the time data may be acquired within the registered signal handler.

For example, the acquisition of the time data through the PPS signal may be a process in which a start time t at the SDP output 234 and a period T of the pulse 236 are designated so that the pulse 236 is periodically emitted, and the application software program 211 may register a signal handler that processes a rising edge event of the pulse 236 and then call GetTime within the registered signal handler to acquire the time data.

Accordingly, when the application software program 211 receives the PPS signal in each period T of the pulse 236, GetTime is called through the time synchronization platform 221 to acquire the time data.

The first counter generation step or operation S311 to be performed in the encryption step or operation S310 and the second counter generation step or operation S321 to be performed in the decryption step or operation S320 may be performed by using the factor synchronized with the acquired time data.

Here, the period T of the pulse 236 may be longer than a time required for the first counter generation step or operation S311, the key stream generation step or operation S312, the first operation or calculation step or operation S313, and the cipher text transmission step or operation S314 included in the encryption step or operation S310. Through this, the first counter 111 and the second counter 121 may be generated through the PPS signal using the pulse 236 having the constant period T, and the encryption/decryption algorithm to which the first counter 111 and the second counter 121 are applied may be stably operated.

Next, a vehicle network security apparatus using a time synchronization-based counter mode according to an embodiment of the present disclosure is described in detail.

A vehicle network security apparatus using a time synchronization-based counter mode according to an embodiment of the present disclosure may include an encryption unit 110 configured to obtain a key stream 113 through a first counter 111 and obtain cipher text 132 by performing the operation 133 on plain text 131 to be encrypted and the key stream 113. A vehicle network security apparatus may also include a decryption unit 120 configured to obtain a key stream 123 through the second counter 121 and obtain the plain text 131 by performing the operation 133 on the cipher text 132 and the key stream 113. The first counter 111 and the second counter 121 may use a factor synchronized with time data transferred from a hardware clock 231 included in a hardware layer 230 of an ECU 200 in a vehicle network, and the first counter 111 and the second counter 121 use the factor synchronized with the time data to have a time error value of 100 ns or less.

Here, when the application software program 211 receives the PPS signal in each period T of the pulse 236, GetTime is called through the time synchronization platform 221 to acquire the time data. The first counter 111 and the second counter 121 are generated by using the factor synchronized with the time data acquired in this way.

After the key stream 113 is obtained through the generated first counter 111, the plain text 131 and the key stream 113 are subjected to the operation 133 to obtain the cipher text 132. After the key stream 123 is obtained through the generated second counter 121, the cipher text 132 and the key stream 123 are subjected to the operation 133 to obtain the plain text 131.

Therefore, the first counter 111 and the second counter 121 may have a time error value of 100 ns or less by using the factor synchronized with the time data transferred from the hardware clock 231.

Since the time data transferred from the hardware clock 231 may have a time error value of 100 ns or less, the time data in us or more may always have the same value from the time stamp confirmed at each rising edge of the PPS signal. That is, the first counter 111 and the second counter 121 may always have the same value of time data in us or more.

Therefore, the first counter 111 and the second counter 121 may use the time data in μs or more.

The terms “include”, “configure”, and “have” described above mean that a component may be included unless otherwise specifically stated, and therefore should be construed as further including other components rather than excluding the other components. All terms including technical or scientific terms have the same meaning as generally understood by those having ordinary skill in the art to which the present disclosure pertains, unless otherwise defined. Terms commonly used, such as terms defined in a dictionary, should be construed as being consistent with the meaning in the context of the related art, and should not be construed in an ideal or overly formal sense unless explicitly defined in the present disclosure.

The above description is merely an illustrative description of the technical idea of the present disclosure, and those having ordinary skill in the art to which the present disclosure pertains may make various modifications and variations without departing from the essential characteristics of the present disclosure. Therefore, the embodiments described in the present disclosure are not intended to limit the technical idea of the present disclosure but are intended to explain the technical idea, and the scope of the technical idea of the present disclosure is not limited by these embodiments. The scope of protection of the present disclosure should be construed by the claims below, and all technical ideas within the equivalent scope should be construed as being included in the scope of the rights of the present disclosure.

What is claimed is:

1. A vehicle network security system using a time synchronization-based counter mode, the vehicle network security system comprising:
an encryption unit configured to
obtain a key stream through a first counter (CTR), and
obtain cipher text by performing an operation on plain text to be encrypted and the key stream; and
a decryption unit configured to
obtain the key stream through a second counter, and
obtain the plain text by performing the operation on the cipher text and the key stream,
wherein the first counter and the second counter use a factor synchronized with time data transferred from hardware clocks (HCs) included in electronic control units (ECUs) in a vehicle network.

2. The vehicle network security system of claim 1, wherein the key stream is obtained through an advanced encryption standard (AES) encryption algorithm.

3. The vehicle network security system of claim 1, wherein the operation performed with the key stream in the encryption unit or the decryption unit includes an exclusive OR (XOR) operation.

4. The vehicle network security system of claim 1, wherein the encryption unit and the decryption unit are configured to perform encryption and decryption, respectively, using a same key stream.

5. The vehicle network security system of claim 1, wherein an ECU, among the ECUs in the vehicle network, includes:
an application layer including an application software program;
a hardware layer including a hardware configuration; and
an adaptive platform layer for an interaction between the application layer and the hardware layer.

6. The vehicle network security system of claim 5, wherein a hardware clock is included in the hardware layer, and wherein the hardware clock includes a hardware clock for an Ethernet-based precision time protocol (PTP).

7. The vehicle network security system of claim 5, wherein the factor synchronized with time data is acquired using a pulse per second (PPS) signal.

8. The vehicle network security system of claim 7, wherein the PPS signal is acquired by i) connecting a software defined pin (SDP) output of an Ethernet controller included in the hardware layer to an SDP Input and ii) performing a setting so that a pulse is periodically emitted from the SDP output.

9. The vehicle network security system of claim 8, wherein:
a signal handler used to process a rising edge of the pulse is registered in the application software program; and
the time data is acquired within the registered signal handler.

10. The vehicle network security system of claim 1, wherein the first counter and the second counter have a time error value of 100 nanosecond (ns) or less by using the factor synchronized with the time data.

11. The vehicle network security system of claim 1, wherein the first counter and the second counter use time data in a microsecond (μs) or more.

12. A vehicle network security communication method using a time synchronization-based counter mode, the vehicle network security communication method comprising:
an encryption step of obtaining a key stream through a first counter and obtaining cipher text by performing an operation on plain text to be encrypted and the key stream; and
a decryption step of obtaining the key stream through a second counter and performing the operation on the cipher text and the key stream to obtain the plain text, wherein
the first counter and the second counter use a factor synchronized with time data transferred from hardware clocks (HCs) included in hardware layers of electronic control units (ECU) in a vehicle network.

13. The vehicle network security communication method of claim 12, wherein the encryption step includes:
a first counter generation step of acquiring a factor synchronized with the time data through a pulse per second (PPS) signal received by an application software program included in an application layer of the ECU and generating the first counter using the factor;
a key stream generation step of obtaining the key stream through the first counter;
a first calculation step of performing the operation on the plain text to be encrypted and the key stream to obtain the cipher text; and
a cipher text transmission step of transmitting the cipher text through the vehicle network.

14. The vehicle network security communication method of claim 13, wherein the decryption step includes:
a second counter generation step of acquiring a factor synchronized with the time data through a pulse per second (PPS) signal received by an application software program included in an application layer of the ECU and generating the second counter using the factor;
a key stream generation step of obtaining the key stream through the second counter; and
a second operation step of performing the operation on the cipher text and the key stream to obtain the plain text.

15. The vehicle network security communication method of claim 14, wherein the first counter generation step performed in the encryption step and the second counter generation step performed in the decryption step are performed at a same point in time.

16. The vehicle network security communication method of claim 14, wherein the key stream generation step performed in the encryption step and the key stream generation step performed in the decryption step are performed at a same point in time.

17. The vehicle network security communication method of claim 14, wherein a time required for the first calculation step and the cipher text transmission step performed in the encryption step is longer than a time required for the second counter generation step and the key stream generation step performed in the decryption step.

18. The vehicle network security communication method of claim 14, wherein:
the PPS signal used in the first counter generation step performed in the encryption step and the second counter generation step performed in the decryption step is acquired by connecting a software defined pin (SDP) output of an Ethernet controller included in a hardware layer to an SDP Input and then performing a setting so that a pulse is periodically emitted from the SDP output; and
a period of the pulse is longer than a time required for the first counter generation step, the key stream generation step, the first calculation step, and the cipher text transmission step included in the encryption step.

19. A vehicle network security apparatus using a time synchronization-based counter mode, the vehicle network security apparatus comprising:
an encryption unit configured to obtain a key stream through a first counter (CTR) and obtain cipher text by performing an operation on plain text to be encrypted and the key stream; and
a decryption unit configured to obtain the key stream through a second counter and obtain the plain text by performing the operation on the cipher text and the key stream, wherein
the first counter and the second counter use a factor synchronized with time data transferred from hardware clocks (HCs) included in hardware layers of electronic control units (ECUs) in a vehicle network, and
the first counter and the second counter have a time error value of 100 nanosecond (ns) or less by using the factor synchronized with the time data.

20. The vehicle network security apparatus of claim 19, wherein the first counter and the second counter use time data in a microsecond (μs) or more.
